(19) United States
(12) Patent Application Publication
(10) Pub. No.: US 2006/0236822 A1
(43) Pub. Date: Oct. 26, 2006

(54) THREADED MEMBER DRIVER WITH RETENTION SYSTEM

(76) Inventor: Jeffery Lynn Nish, Centerville, UT (US)

Correspondence Address: HOLLAND & HART LLP, 60 E. SOUTH TEMPLE, SUITE 2000, SALT LAKE CITY, UT, 84111, US

(21) Appl. No.: 11/379,485

(22) Filed: Apr. 20, 2006

Related U.S. Application Data
(60) Provisional application No. 60/674,938, filed on Apr. 26, 2005.

(51) Int. Cl. B25B 13/06

(52) U.S. Cl. 81/125; 81/121.1

(57) ABSTRACT

The present disclosure provides methods and apparatus for driving threaded members. The methods and apparatus facilitate holding or retaining a threaded member with a driver. Therefore, the driver and the threaded member may be coupled together at any orientation without separation until separation is desired. Threaded members can be fastened at any angle with one hand. Some embodiments provide electrical insulators for both a handle and a shank of the driver.

### RELATED APPLICATIONS

This claims priority under 35 U.S.C. § 119(e) of U.S. Provisional Patent Application No. 60/674,938 filed 26 Apr. 2005 and entitled “Hex nut driver screw retention system,” which is commonly owned by the present inventor and hereby incorporated by reference in its entirety.

### BACKGROUND

The present disclosure is directed to tools, including hand tools, threaded member drivers, socket drivers, and nut and bolt drivers. Hand tools including socket drivers, nut drivers, screwdrivers, and the like have been known for many years. Such hand tools offer laypersons and craftsman a mechanical advantage when rotating threaded fasteners of all kinds. Threaded fasteners are often used to attach structural components to one another.

Some conventional threaded member drivers include a hollow end formed with a polygonal socket. The polygonal socket typically fits over a threaded member such as a nut or a bolt. However, the threaded member is normally not secured in the polygonal socket, and often falls out. This results in regular inconvenience during operation. It is not uncommon to find fasteners on horizontal, vertical, and other surfaces that tend to make it difficult to keep the threaded member in the polygonal socket.

Attempts to reduce slipping of threaded members have had limited success. For example, some wrenches include a stopper to limit insertion of threaded members into the socket. However, when the wrench is lifted, the threaded member still slips downward and out of the socket. In other words, even wrenches with stoppers are unable to hold the threaded member in the socket.

In addition, threaded member drivers are commonly used in many applications including plumbing, woodworking, and electrical work. One problem associated with traditional threaded member drivers when used for electrical work is exposure to electrical currents. Typical threaded member drivers are metal conductors. Although some threaded member drivers include electrically insulating handles, the shanks extending from the handles are metal. Users are constantly exposed to the metal shanks, and this exposure can create a number of problems. For example, a user may contact an electrical power source with the shank (or a conductive fastener in the shank). The user can be easily shocked by a simple slip or loss of concentration, which may cause the operator to inadvertently touch the shank.

There is a need, therefore, for more safe and effective threaded member drivers.

### SUMMARY OF THE INVENTION

The principles described herein may address some of the above-described deficiencies and others. Specifically, some of the principles described herein relate to threaded member driver apparatuses and methods.

One embodiment provides a threaded member driver comprising a handle, a shank extending from the handle having a proximal end and distal end, a cavity disposed in the shank and having an open end, a circumferential groove extending at least partially around an outside surface of the cavity, a lateral hole in the circumferential groove leading into the cavity, and a retaining member disposed in the circumferential groove and extending through the hole into the cavity. In one embodiment, the proximal end of the shank is attached to the handle and the distal end is free. In one embodiment, the cavity comprises a hexagonal cavity receptive of a hexagonal threaded member such as a nut or bolt. In one embodiment, the cavity comprises a hexagonal cavity, and the lateral hole extends through the shank at one hexagonal wall. In one embodiment, the cavity comprises a hexagonal cavity receptive of a hexagonal nut or bolt, and the retaining member contacts and retains the hexagonal nut or bolt in the cavity.

According to one aspect, the retaining member of the threaded member driver comprises a spring clip. In one embodiment, the retaining member comprises an arced clip having a radially inward detent extending through the lateral hole and protruding into the cavity. In one embodiment, the retaining member comprises a flexible wire. A first portion of the flexible wire may be disposed in the circumferential groove, and a second portion of the flexible wire may curve into the lateral hole, protrude to an apex inside the cavity, and return out of the lateral hole. In one embodiment, the retaining member comprises a flexible protrusion extending into the cavity for providing a biasing retention force against an inserted threaded member.

According to one embodiment of the threaded member driver, the handle and the shank both comprise electrically insulating materials.

One aspect provides a fastener driving apparatus comprising a longitudinal threaded member driver. The longitudinal threaded member driver comprising a handle, a shank attached to and extending coaxially from the handle, a recess disposed in a distal end of the shank, the recess being coaxial with the shank and the handle, an aperture in a side of the shank at the recess, and a bias member extending through the aperture and protruding into the recess for snugly holding a threaded member in the recess. In one embodiment, the shank comprises an outer annular groove aligned with the aperture, and the bias member is at least partially disposed in the outer annular groove.

In one embodiment of the fastener driving apparatus, the bias member comprises a generally convex arc portion, and a generally concave arc portion. In one embodiment, the shank comprises an outer annular groove aligned with the aperture. In one embodiment, the convex arc portion is disposed in the outer annular groove, and the concave arc portion extends through the aperture.

In one embodiment of the fastener driving apparatus, the recess comprises a hexagonal cavity, and the aperture extends through the shank at only one hexagonal wall. In one embodiment, the handle and the shank both comprise electrically insulative materials.

One embodiment provides a nut and bolt driver. The nut and bolt driver comprise a handle, a shank attached to the handle and coaxial with the handle, a hollow cavity disposed in a distal end of the shank, an outer groove disposed at the hollow cavity holding a retaining ring, and a hole through the shank at a flat side surface of the hollow cavity. The hollow cavity comprises a polygonal shape having a plurality of flat side surfaces, and a portion of the retaining ring protrudes through the hole and into the hollow cavity. In one embodiment, the hollow cavity comprises a hexagonal cavity, and the aperture extends through the shank at only one hexagonal wall. The retaining ring may comprise a convex portion and a radially inward portion. The radially inward portion extends through the hole. In one embodiment of the nut and bolt driver, the retaining ring comprises a semi-circular arc. The semi-circular arc includes a convex portion and a radially inward portion at a first end of the semi-circular are.

One embodiment provides a threaded member driver comprising a shank having a proximal end and distal end, a cavity disposed in the shank at the distal end, the cavity having an open end, a continuous circumferential groove extending at least partially around an outside surface of the cavity, a lateral hole in the shank at the circumferential groove leading into the cavity, and a retaining member disposed in the circumferential groove and extending through the hole into the cavity. In one embodiment, the proximal end is adapted to removably attach to a handle. The handle may be part of a ratchet, a nut driver, a wrench, a power tool, or other component.

One aspect provides a method of fastening. The method includes providing a fastening driver having a handle, a shank extending from the handle, a cavity disposed in the shank and having an open end, a circumferential groove extending at least partially around an outside surface of the cavity, a lateral hole in the circumferential groove leading into the cavity, and a retaining member disposed in the circumferential groove and extending through the hole into the cavity. The method further includes placing a fastener in the cavity, holding the fastener in the cavity with the retaining member, rotating the fastener, and removing the fastening driver from the fastener. In one aspect, holding comprises biasing the retaining member to an interference fit with the fastener. In one aspect, holding comprises applying pressure from the retaining member to the fastener and snugly holding the fastener with the pressure. In one aspect, holding comprises blocking the fastener from falling out of the cavity. In one aspect, holding comprises passing at least a portion of the fastener past the retaining member, moving the retaining member radially into the cavity, and blocking the fastener from falling out of the cavity with the retaining member.

The methods and apparatus facilitate safe and convenient threaded member driving, as well as providing electrical insulating protection in some embodiments. The methods and apparatus may be used to hold threaded members in any orientation without dropping the threaded member.

Other features and advantages will become apparent from the following detailed description with reference to the accompanying drawings.

### BRIEF DESCRIPTION OF THE DRAWINGS

The accompanying drawings illustrate certain embodiments discussed below and are a part of the specification.

FIG. 1 is a perspective assembly view of a threaded member driver according to one embodiment.

FIG. 2 is a perspective assembled view of the threaded member driver of FIG. 1.

FIG. 3 is a cross sectional view, taken along line 3-3, of the threaded member driver of FIG. 2.

FIG. 4 is a cross sectional view, taken along line 3-3, of the threaded member driver of FIG. 2 with an inserted nut or bolt.

FIG. 5 is a cross sectional view, taken along line 5-5, of the threaded member driver of FIG. 2.

FIGS. 6A-6B illustrate a bolt being inserted into a threaded member driver according to one embodiment.

FIG. 7 is a perspective view of a retaining ring according to one embodiment.

FIG. 8 is a perspective view of a retaining ring according to another embodiment.

FIG. 9 is a perspective view of a truncated threaded member driver or socket according to one embodiment.

Throughout the drawings, identical reference characters and descriptions indicate similar, but not necessarily identical, elements.

### DETAILED DESCRIPTION

Illustrative embodiments and aspects are described below. It will of course be appreciated that in the development of any such actual embodiment, numerous implementation-specific decisions must be made to achieve the developers' specific goals, such as compliance with system-related and business-related constraints, that will vary from one implementation to another. Moreover, it will be appreciated that such a development effort might be complex and time-consuming, but would nevertheless be a routine undertaking for those of ordinary skill in the art having the benefit of this disclosure.

As used throughout the specification and claims, the term “convex” means having a surface or boundary that curves or bulges outward. “Concave” means having a surface or boundary that curves or protrudes inward. In reference to a retaining member, “concave” and “convex” are from an outside perspective, rather than an internal perspective with respect to the retaining member. An “arc” is a curve or an arch, which may have an apex or other feature. A “longitudinal driver” or a “longitudinal threaded member driver” refers to a driver having a handle that is rotated about a longitudinal axis that is substantially parallel to an axis of rotation of a fastener being driven. The words “including” and “having,” as used in the specification, including the claims, have the same meaning as the word “comprising.”

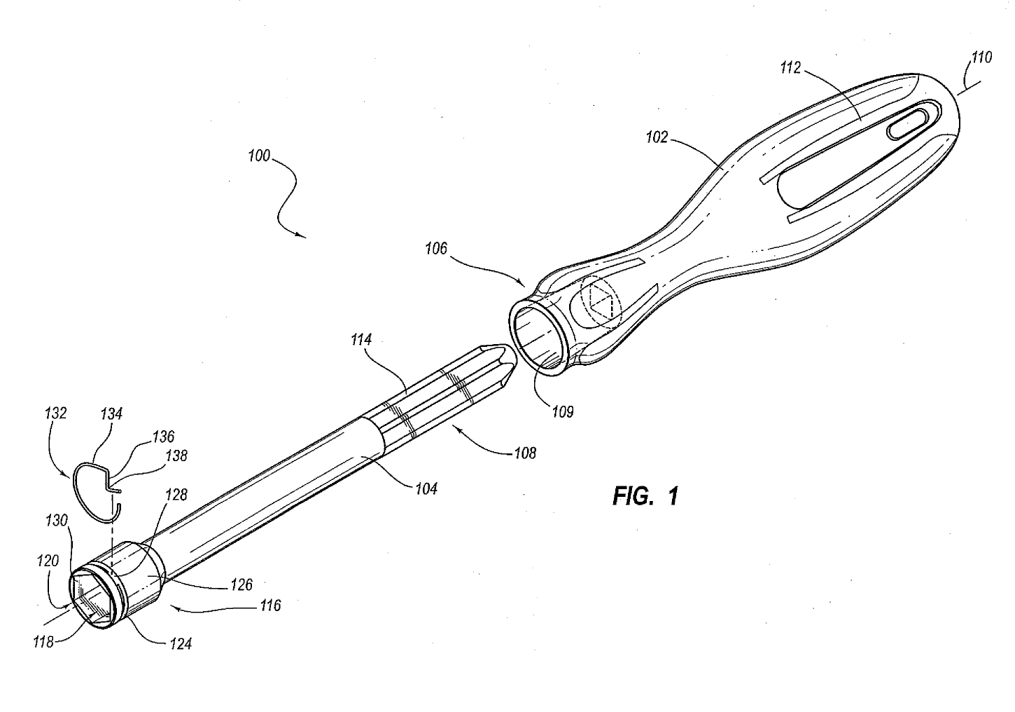

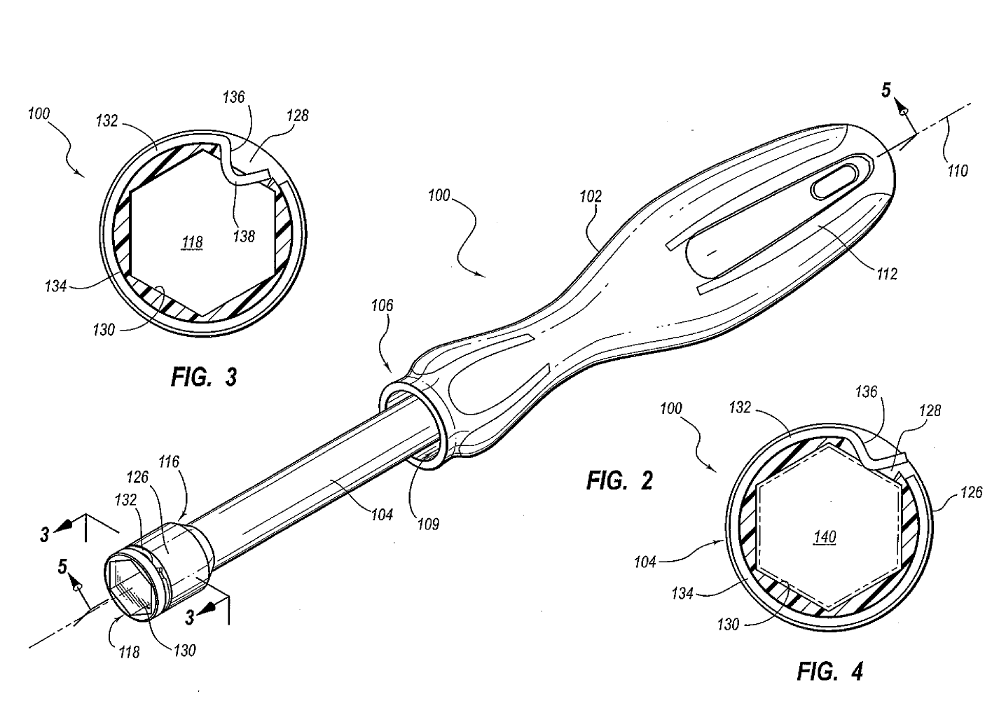

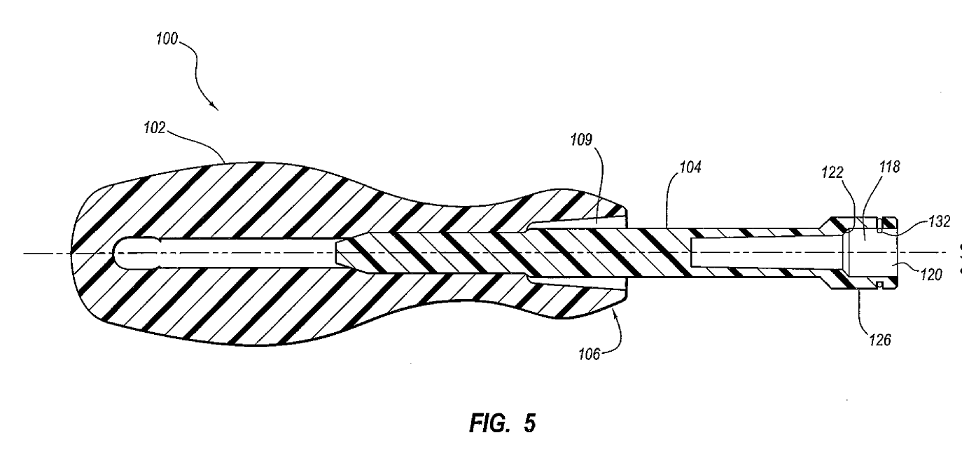

Turning now to the figures, and in particular to FIGS. 1-5, one embodiment of a fastener driving apparatus is shown. The fastener driving apparatus may comprise, for example, a threaded member driver 100. The threaded member driver 100 includes a handle 102. According to one embodiment, the handle 102 comprises a rigid, electrically insulating material. In one embodiment, the electrically insulating material comprises a structural plastic. A shank 104 extends from a distal end 106 of the handle 102. The shank 104 also comprises a rigid material. In one embodiment, the shank 104 comprises an electrically insulating material such as structural plastic. The shank 104 may be hollow or substantially solid.

In one embodiment, a proximal end 108 of the shank 104 is co-formed inside of the handle 102 and substantially integral with the handle 102. Therefore, the proximal end 108 is attached to the handle 102. However, in one embodiment, the handle 102 comprises a cavity 109 at the distal end 106 forming an annulus between a portion of the handle 102 and a portion of the shank 104. Nevertheless, the shank 104 extends beyond the extents of the distal end 106 of the handle 102. In one embodiment, the handle 102 is substantially hollow and receptive of the shank 104. The proximal end 108 of the shank 104 may be permanently press-fit into the handle 104 in one embodiment. In one embodiment, the shank 104 is removably or interchangeably inserted into the handle 104. Therefore, shanks with various distal features may be interchangeable with the handle 104 in some embodiments.

In one embodiment, the handle 102 and the shank 104 are substantially cylindrical and coaxial with one another about a longitudinal axis 110. In one embodiment, the handle 102 includes a gripping outer surface that may comprise any number of radial protrusions 112 or other features. The proximal end 108 of the shank 104 may comprise a generally square or rectangular cross section, with rounded, protruding bulbs 114 at what would otherwise be corners of the square or rectangle.

As shown in FIGS. 1-5, in one embodiment, a distal end 116 of the shank 104 is free. The distal end 116 of the shank may comprise a recess or cavity 118 having an open end 120. The cavity 118 may be substantially coaxial with the longitudinal axis 110. A shoulder 122 inside the cavity 118 and spaced from the open end 120 may limit the insertion depth of any associated fasteners or threaded members into the cavity 118. According to one embodiment, the cavity 118 comprises an internal polygonal shape. As shown in FIGS. 1-5, the cavity 118 may exhibit a hexagonal shape. Nevertheless, any polygonal shape or non-polygonal shape sized to match an associated threaded member may be used.

According to one embodiment, the distal end 116 of the shank 104 includes an annular or circumferential groove 124 extending at least partially around an outside surface 126 of the shank 104. As shown in FIGS. 1-5, in one embodiment, the outside surface 126 at the distal end 116 may comprise a larger diameter than other portions of the shank 104, but this is not necessarily so. The outside surface 126 and the cavity 118 may be sized to accommodate any size threaded member. According to one embodiment, the circumferential groove 124 is continuous and extends around the outside surface 126 in a complete, closed, circle, ellipse, or other shape.

In one embodiment, the shank 104 includes a lateral aperture or hole 128 therethrough at the cavity 118. In one embodiment, the hole 128 is disposed in the circumferential groove 124. According to one embodiment, the hole 128 extends substantially the same length as one flat 130 of the polygonal shape of the cavity 118. The hole 128 may be approximately the same width as the width of the circumferential groove 124.

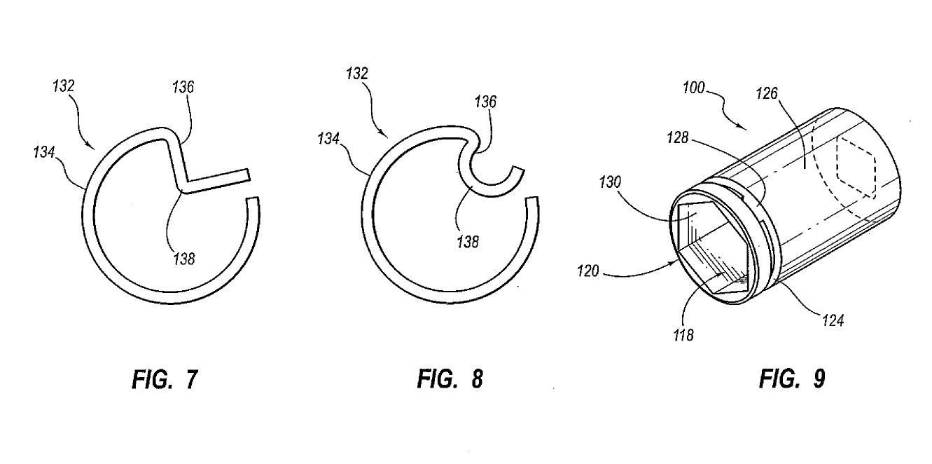

In one embodiment, the circumferential groove 124 is receptive of a retaining member or a bias member. As shown in FIGS. 1-5, the retaining member or bias member may comprise a spring clip 132. The spring clip 132 may include a flexible wire made of metal, plastic, or other material that is sized to expand and clip into the circumferential groove 124. In one embodiment, the spring clip 132 is open and arced. As shown in FIGS. 3-4, the spring clip 132 may comprise multiple shapes or portions. According to the embodiment of FIG. 7, the spring clip 132 comprises an arc with a radial inward detent. For example, the spring clip 132 may comprise generally convex arc portion 134 and a generally concave arc portion 136. The generally convex arc portion 134 rests in the circumferential groove 124 (FIG. 1). The generally concave arc portion 136 or other inward detent is aligned with the hole 128. Accordingly, at least a portion of the generally concave arc portion 136 extends through the hole 128 and protrudes into the cavity 118. As discussed below, the generally concave arc portion 136 may flex and snugly hold a threaded member or other fastener in the cavity 118.

As shown in FIG. 3, the spring clip 132 may include the generally concave arc portion 136 that protrudes inward to an apex 138. Accordingly, the generally concave arc portion 136 may curve into the hole 128, protrude to the apex 138, and return back out of the hole 128.

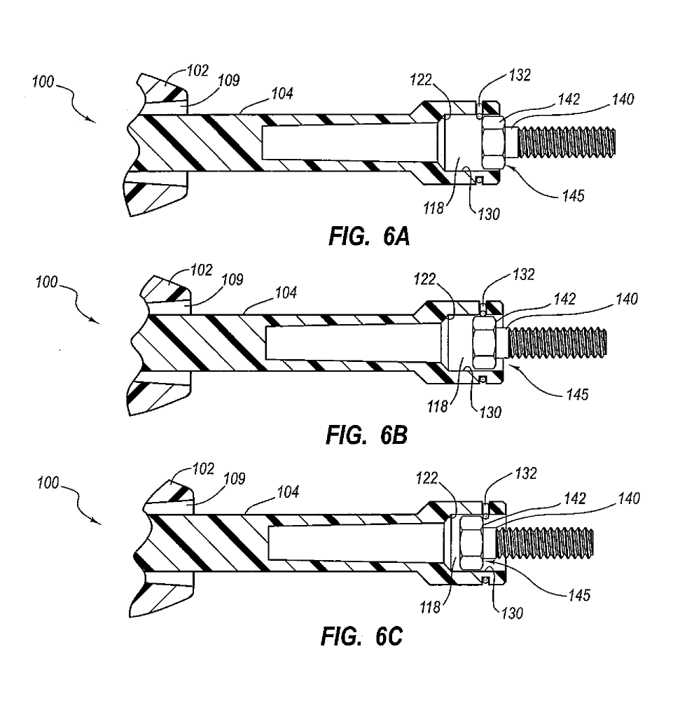

The spring clip 132 or other retention member holds a threaded member such as a nut or bolt in the cavity 118. As shown in FIGS. 4 and 6A-6C, the cavity 118 is receptive of a fastener such as a bolt 140. When the bolt 140 is inserted into the hexagonal cavity 118, the concave arc portion 136 extending through the hole 128 bears against or contacts a surface 142 of the bolt 140. The concave arc portion 136 may deform and/or flex partially back out of the hole 128 as shown in FIGS. 4 and 6B, and provides a biasing force against the bolt 140 sufficient to hold the bolt 140 snugly within the cavity 118 at any orientation of the threaded member driver 100. The concave arc portion 136 or other detent through the hole 128 creates a friction fit of the bolt 140 between the concave arc portion 136 and the flat inside surfaces 130 of the cavity. Nevertheless, a user can selectively and easily remove the bolt 140 or any other threaded member from the cavity 118 by the application of a relatively small axial force between the bolt 140 and the threaded member driver 100. The fit between the bolt 140 and the concave arc portion 136 may also be characterized as an interference fit in some embodiments, as insertion of the bolt 140 or other fastener displaces and/or deforms a portion of the concave arc portion 136. In some embodiments, the cavity 118 is deep enough to allow a shallow head 145 of a bolt or other threaded member to pass by the spring clip 132 as shown in FIG. 6C. A shallow nut might fully insert into the cavity 118 beyond the spring clip 132. Accordingly, the concave arc portion 136 may hold the bolt 140 or other threaded member inside the cavity 118 by springing back into the cavity 118 after the head 145 of the bolt passes thereby. The concave arc portion 136 thus blocks the bolt from falling out of the cavity 118.

Accordingly, a user can insert the bolt 140 or any other threaded member into the threaded member driver 100, maneuver the threaded member driver 100 (and thus the bolt 140) to any position with one hand, and then proceed to rotate the bolt 140 and fasten an item. Similarly, a nut or any other threaded member may be inserted and held in the cavity 118. As mentioned above, in some embodiments, including those that include an interchangeable shank 104, the shank 104 may be replaced with another shank having a different size cavity 118 to accommodate threaded members of other sizes or shapes.

In one embodiment, the inward detent of the spring clip 132 includes the generally concave portion 136 shown in FIGS. 7-8. However, the generally concave portion 136 may be V-shaped as shown in FIG. 7 and include the apex 138 at the vertex of V-shape, or the generally concave portion 136 may comprise a more arced or curved configuration as shown in FIG. 8. Other shapes, including shapes wherein an end of the spring clip 132 protrudes through the hole 128 (FIG. 3) and does not curve back out may also be used.

In one embodiment, the threaded member driver 100 is truncated as shown in FIG. 9 and does not include a handle. In such an embodiment, the threaded member driver 100 may comprise a socket connectable to any socket handle, power tool, or other device. Similar to other embodiments described above, the threaded member driver 100 of FIG. 9 retains or holds any threaded member that may be sized for insertion into the cavity 118 until an operator desires to disconnect the threaded member driver 100 from the fastener.

One aspect thus provides a method of fastening. The method may include providing a fastening driver having a handle, with a shank extending from the handle. A cavity may be disposed in the shank that comprises an open end, and a circumferential groove may extend at least partially around an outside surface of the cavity. A lateral hole in the circumferential groove may lead into the cavity, and a retaining member is disposed in the circumferential groove and extends through the hole into the cavity. The method may further include placing a fastener in the cavity, holding the fastener in the cavity with the retaining member, rotating the fastener, and removing the fastening driver from the fastener. In one aspect, holding comprises biasing the retaining member to an interference fit with the fastener. In one aspect, holding comprises applying pressure from the retaining member to the fastener and snugly holding the fasting member with the pressure, or blocking removal of the fastening member. The methods and apparatus may be used to hold threaded members in any orientation without dropping the threaded member.

The methods and apparatus facilitate safe and convenient threaded member driving, as well as providing electrically insulating protection in some embodiments. As mentioned above, in some embodiments, both the handle 102 and the shank 104 comprise electrically insulating materials. Therefore, an operator may attach a fastener to a live electrical component without touching the fastener in any way once the fastener is inserted into the cavity 118. When the fastening operation is complete, simply pulling the threaded member driver 100 away from the fastener will separate the two. Moreover, even if the operator inadvertently touches the shank 104 while a fastener is in contact with a live electrical source, the shank 104 will not conduct electricity to the operator. The operator may attach any component in a live electrical setting with confidence.

The preceding description has been presented only to illustrate and describe certain aspects, embodiments, and examples of the principles claimed below. It is not intended to be exhaustive or to limit the described principles to any precise form disclosed. Many modifications and variations are possible in light of the above teaching. Such modifications are contemplated by the inventor and within the scope of the claims. The scope of the principles described is defined by the following claims.

What is claimed is:

1. A threaded member driver comprising:
a handle;
a shank extending from the handle having a proximal end and distal end, wherein the proximal end is attached to the handle and the distal end is free, the distal end comprising:
a cavity disposed in the shank and having an open end;
a circumferential groove extending at least partially around an outside surface of the cavity;
a lateral hole in the circumferential groove leading into the cavity;
a retaining member disposed in the circumferential groove and extending through the hole into the cavity.

2. A threaded member driver according to claim 1 wherein the cavity comprises a hexagonal cavity receptive of a hexagonal threaded member.

3. A threaded member driver according to claim 1 wherein the cavity comprises a hexagonal cavity, and wherein the lateral hole extends through the shank at one hexagonal wall.

4. A threaded member driver according to claim 1 wherein the cavity comprises a hexagonal cavity receptive of a hexagonal nut or bolt, wherein the retaining member contacts and retains the hexagonal nut or bolt.

5. A threaded member driver according to claim 1 wherein the retaining member comprises a spring clip.

6. A threaded member driver according to claim 1 wherein the retaining member comprises an arced clip having a radially inward detent extending through the lateral hole and protruding into the cavity.

7. A threaded member driver according to claim 1 wherein the retaining member comprises a flexible wire, wherein a first portion of the flexible wire is disposed in the circumferential groove, and a second portion of the flexible wire curves into the lateral hole, protrudes to an apex inside the cavity, and returns out of the lateral hole.

8. A threaded member driver according to claim 1 wherein the retaining member comprises a flexible protrusion extending into the cavity for providing a biasing retention force against an inserted threaded member.

9. A threaded member driver according to claim 1 wherein the handle and the shank both comprise electrically insulating materials.

10. A fastener driving apparatus, comprising:
a longitudinal threaded member driver, the longitudinal threaded member driver comprising:
a handle;
a shank attached to and extending coaxially from the handle;
a recess disposed in a distal end of the shank, the recess being coaxial with the shank and the handle;
an aperture in a side of the shank at the recess;
a bias member extending through the aperture and protruding into the recess for snugly holding a threaded member in the recess.

11. A fastener driving apparatus according to claim 10 wherein the shank comprises a continuous outer annular groove aligned with the aperture, wherein the bias member is at least partially disposed in the outer annular groove.

12. A fastener driving apparatus according to claim 10 wherein the bias member comprises:
a generally convex arc portion;
a generally concave arc portion.

13. A fastener driving apparatus according to claim 10 wherein the bias member comprises:
a convex arc portion;
a concave arc portion;
wherein the shank comprises an outer annular groove aligned with the aperture;
wherein the convex arc portion is disposed in the outer annular groove, and the concave arc portion extends through the aperture.

14. A fastener driving apparatus according to claim 10 wherein the recess comprises a hexagonal cavity, and wherein the aperture extends through the shank at only one hexagonal wall.

15. A fastener driving apparatus according to claim 10 wherein the handle and the shank both comprise electrically insulative materials.

16. A nut and bolt driver, comprising:
a handle;
a shank attached to the handle and coaxial with the handle;
a hollow cavity disposed in a distal end of the shank, the hollow cavity comprising a polygonal shape having a plurality of flat side surfaces;
a continuous outer groove disposed at the hollow cavity holding a retaining ring;
a hole through the shank at one flat side surface of the hollow cavity;
wherein a portion of the retaining ring protrudes through the hole and into the hollow cavity.

17. A nut and bolt driver 16 wherein the hollow cavity comprises a hexagonal cavity, and wherein the aperture extends through the shank at only one hexagonal wall.

18. A nut and bolt driver 16 wherein the retaining ring comprises:
a convex portion;
a radially inward portion;
wherein the radially inward portion extends through the hole.

19. A nut and bolt driver 16 wherein the retaining ring comprises:
a semi-circular arc comprising:
a convex portion;
a radially inward portion at a first end of the semi-circular arc;
wherein the radially inward portion extends through the hole.

20. A threaded member driver comprising:
a shank having a proximal end and distal end,
a cavity disposed in the shank at the distal end, the cavity having an open end;
a continuous circumferential groove extending at least partially around an outside surface of the cavity;
a lateral hole in the shank at the circumferential groove leading into the cavity;
a retaining member disposed in the circumferential groove and extending through the hole into the cavity.

21. A threaded member driver according to claim 20 wherein the proximal end is adapted to removably attach to a handle.

22. A method of fastening, comprising:
providing a fastening driver having:
a handle;
a shank extending from the handle;
a cavity disposed in the shank and having an open end;
a circumferential groove extending at least partially around an outside surface of the cavity;
a lateral hole in the circumferential groove leading into the cavity;
a retaining member disposed in the circumferential groove and extending through the hole into the cavity;
placing a fastener in the cavity;
holding the fastener in the cavity with the retaining member;
rotating the fastener;
removing the fastening driver from the fastener.

23. A method of fastening according to claim 22, wherein the holding comprises biasing the retaining member to an interference fit with the fastener.

24. A method of fastening according to claim 22, wherein the holding comprises applying pressure from the retaining member to the fastener and snugly holding the fastener with the pressure.

25. A method of fastening according to claim 22, wherein the holding comprises blocking the fastener from falling out of the cavity.

26. A method of fastening according to claim 22, wherein the holding comprises passing at least a portion of the fastener past the retaining member, moving the retaining member radially into the cavity, and blocking the fastener from falling out of the cavity with the retaining member.
